(19) United States
(12) Patent Application Publication
(10) Pub. No.: US 2022/0316915 A1
(43) Pub. Date: Oct. 6, 2022

(54) INFORMATION PROCESSING DEVICE, INFORMATION PROCESSING METHOD, AND NON-TRANSITORY COMPUTER READABLE STORAGE MEDIUM

(71) Applicant: Yahoo Japan Corporation, Tokyo (JP)

(72) Inventors: Kota TSUBOUCHI, Tokyo (JP); Tatsuru HIGURASHI, Tokyo (JP); Junichi SATO, Tokyo (JP); Kenta KANAMORI, Tokyo (JP)

(21) Appl. No.: 17/690,970

(22) Filed: Mar. 9, 2022

(30) Foreign Application Priority Data
Mar. 19, 2021 (JP) 2021-046063

(51) Int. Cl. G01C 21/00

(52) U.S. Cl. CPC G01C 21/3856; G01C 21/3844; G01C 21/3889

(57) ABSTRACT

An information processing device includes an acquisition unit acquires a data set in which each data includes information regarding a position, an estimation unit estimates a position value indicating a value related to a position of target data that is data to be a target of value estimation based on evaluation in a predetermined task of data sets including mutually different data, a decision unit decides whether to transmit the target data to an external device based on a non-transmission index that is set based on an instruction of a user, and transmission unit transmits the target data to the external device in accordance with the decision made by the decision unit.

### CROSS-REFERENCE TO RELATED APPLICATIONS

The present application claims priority to and incorporates by reference the entire contents of Japanese Patent Application No. 2021-046063 filed in Japan on Mar. 19, 2021.

### BACKGROUND OF THE INVENTION

### 1. Field of the Invention

The present invention relates to an information processing device, an information processing method, and an information processing program.

### 2. Description of the Related Art

Various technologies using information regarding a position of a user, a terminal device, or the like have been provided. For example, a technique of estimating a movement status of a user using position information has been provided (for example, Patent Literature 1). In addition, for example, a technique of updating information of a route candidate based on a transition state of position information is provided (for example, Patent Literature 2 or the like).

However, information transmitted from a terminal device carried by the user to an external device sometimes includes information not desired by the user to be transmitted. In view of this, it is desired that information provided from the terminal device to the external device is appropriately provided in a manner desired by the user.

### SUMMARY OF THE INVENTION

An information processing device includes an acquisition unit that acquires a data set in which each piece of data constituting the data set includes information regarding a position, an estimation unit that estimates a position value indicating a value related to a position of target data that is data to be a value estimation target, based on evaluation in a predetermined task of each of the data sets including mutually different data, a decision unit that decides whether to transmit the target data to an external device based on a non-transmission index that is set based on an instruction of a user, and a transmission unit that transmits the target data to the external device in accordance with the decision made by the decision unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of information processing according to an embodiment;

FIG. 2 is a diagram illustrating a configuration example of an information processing system according to the embodiment;

FIG. 3 is a diagram illustrating a configuration example of a terminal device according to the embodiment;

FIG. 4 is a flowchart illustrating an example of information processing according to the embodiment;

FIG. 5 is a diagram illustrating an example of processing in the information processing system according to the embodiment;

FIG. 6 is a diagram illustrating a data set for which suitability of transmission to a server device is determined by setting a non-transmission index;

FIG. 7 is a diagram illustrating a data set transmitted to a server device;

FIG. 8 is a flowchart illustrating an example of information processing according to the embodiment; and

FIG. 9 is a diagram illustrating an example of a hardware configuration.

### DETAILED DESCRIPTION OF THE PREFERRED EMBODIMENTS

Hereinafter, modes (hereinafter referred to as “embodiments”) for implementing an information processing device, an information processing method, and an information processing program according to the present application will be described in detail with reference to the drawings. Note that the information processing device, the information processing method, and the information processing program according to the present application are not limited by the embodiment. Note that the same parts in each of the following embodiments are designated by the same reference numerals, and duplicate description is omitted.

### EMBODIMENTS

1. Information Processing

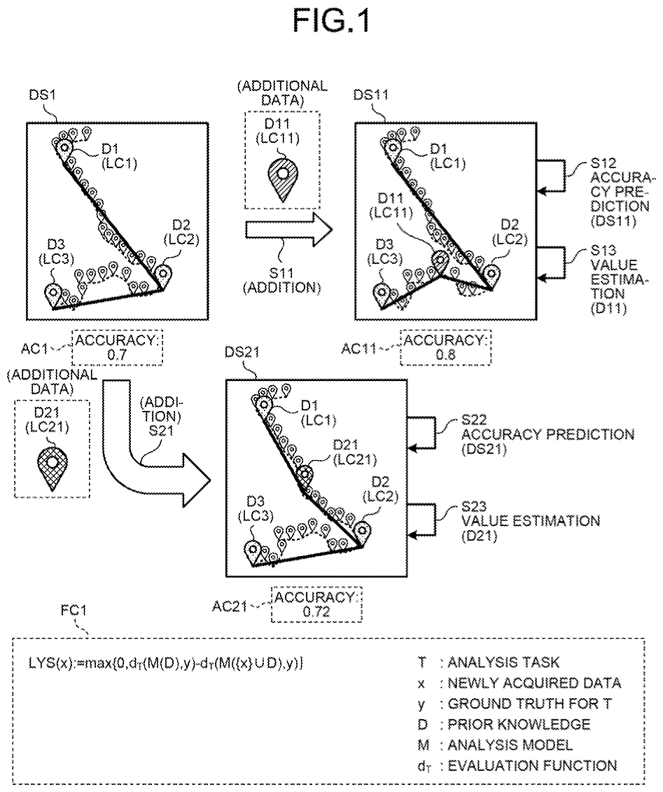

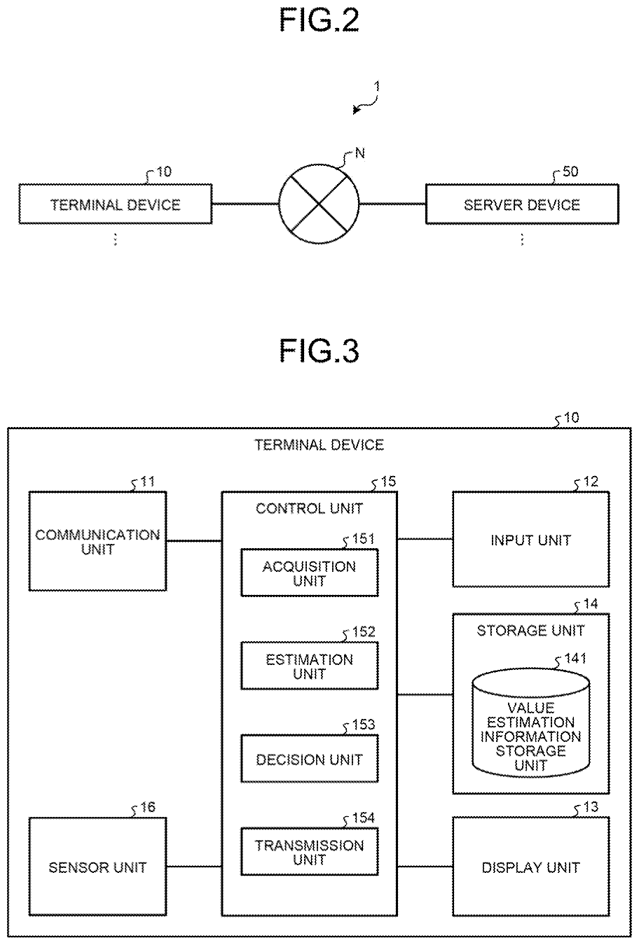

Next, an example of information processing according to an embodiment will be described with reference to FIG. 1. FIG. 1 is a diagram illustrating an example of information processing according to an embodiment. FIG. 1 illustrates an exemplary case where an information processing system 1 (refer to FIG. 2) performs estimation processing of estimating a value related to a data position (also referred to as “position value”). Hereinafter, data to be a position value estimation target may be referred to as “target data”. Note that the target data may be one piece of data or a plurality of pieces of data (data group), which will be described below. The example of FIG. 1 illustrates information processing such as estimation of the position value of the target data executed by a terminal device 10 (refer to FIG. 2). Although the following description uses the information processing system 1 as a processing subject, each processing may be performed by any device included in the information processing system 1 as long as the processing can be executed. That is, any of the terminal device 10, a server device 50, and the like included in the information processing system 1 may perform the processing described as being processed by the information processing system 1 as the processing subject.

FIG. 1 uses an exemplary case where data is added to a data set DS1 including three pieces of data D1, D2, and D3 and describes a case of estimating the position value of data added to the data set DS1 (also referred to as “additional data”). That is, in FIG. 1, the additional data is the target data. Individual pieces of data such as a data group of a data set (data D1, D2, and D3 in FIG. 1) and additional data (data D11 (LC11) and D21 in FIG. 1) is not limited to data of the same type (for example, data collected in the same service), and may be any type of data as long as each data includes information related to position. That is, each data such as the data group of the data set and the additional data may be any data as long as the data includes information related to position.

For example, each data such as a data group of a data set and additional data is not limited to data including position information detected by a global positioning system (GPS) sensor or the like, and may be, for example, payment data in an electronic payment service using the terminal device 10, check-in data using the terminal device 10, posting data to a predetermined social networking service (SNS) service including a tool referred to as a geotag, or the like. The type of the above data is merely an example, and each data such as a data group of a data set and additional data may be various types of data such as search data using the terminal device 10 and product purchase data or the like using the terminal device 10. In this manner, each data such as the data group of the data set and the additional data may be any type of data as long as the data is location-related data including information related to position/location.

In FIG. 1, the data D1 is data including position information LC1. In an example of FIG. 1, the position information is illustrated by an abstract code such as the position information LC1. However, the position information may be various types of information related to the location, such as information indicating a specific latitude/longitude (latitude/longitude information) or an area, information indicating an access point of wireless communication, and information indicating a store where electronic payment has been made. Furthermore, “position information LC* (* is a certain numerical value)” will be described as “position LC*” in some cases. In addition, the data D2 is data including position information LC2, and data D3 is data including position information LC3.

FIG. 1 illustrates, as represented by accuracy information AC1, a case where the accuracy “0.7” is obtained when a data set DS1 including three pieces of data D1, D2, and D3 is used for a predetermined task. Note that the predetermined task may be a service related to a service provided using information related to a position. FIG. 1 is an exemplary case where a predetermined task is user's commuting route estimation.

The accuracy in the predetermined task is derived by an analysis model M for accuracy measurement, indicated in position value estimation information FC1. Using the analysis model M, the information processing system 1 predicts accuracy to be obtained when the data set DS1 is used for a predetermined task. For example, by inputting the data set DS1 to the analysis model M, the information processing system 1 uses an output value that has been output from the analysis model M as the accuracy to be obtained when the data set DS1 is used for a predetermined task. That is, FIG. 1 illustrates a case where the analysis model M outputs “0.7” after having received an input of the data set DS1. For example, an information processing device (for example, the terminal device 10 or the like) that estimates the position value in the information processing system 1 acquires the analysis model M generated by another device (for example, an analysis model generation device or the like) from the another device. Note that the analysis model M may be generated by an information processing device (for example, the terminal device 10 or the like) that estimates the position value in the information processing system 1. For example, in FIG. 1, the information processing system 1 may set a matching rate between a predicted route indicated by a solid line predicted using the data set DS1 and an actual commuting route of the user indicated by a dotted line, as the accuracy of the data set DS1. Note that the pin pointer on the dotted line indicated by the pin pointer smaller than the pin pointer such as the data D1 to D3 in FIG. 1 is a pointer for indicating the actual commuting route of the user, and is defined as data not included in the data set DS1.

The information processing system 1 adds data D11 being additional data to the data set DS1 (step S11). Subsequently, the information processing system 1 derives accuracy for the data set DS11 obtained by adding the data D11 to the data set DS1. For example, using the analysis model M, the information processing system 1 predicts accuracy to be obtained when the data set DS11 is used for a predetermined task (step S12). FIG. 1 illustrates, as represented by accuracy information AC11, a case where the accuracy “0.8” is obtained when a data set DS11 including added data D11 is used for a predetermined task. For example, after inputting the data set DS11 to the analysis model M, the information processing system 1 predicts an output value “0.8” output from the analysis model M as the accuracy to be obtained when the data set DS11 is used for a predetermined task.

Subsequently, the information processing system 1 estimates the position value of the data D11 being the additional data (step S13). For example, the information processing system 1 estimates the position value of the data D11 being the additional data by using the accuracy “0.7” to be obtained when the data set DS1 is used for a predetermined task and using the accuracy “0.8” to be obtained when the data set DS11 is used for a predetermined task. Specifically, the information processing system 1 estimates the position value of the data D11 being the additional data, by using the following Formula (1).

LYS(x):=max{0,d_{T}(M(D),y)−d_{T}(M({x}∪D),y)} (1)

The above Formula (1) is similar to the formula illustrated in the position value estimation information FC1 in FIG. 1, and thus, description will be given of each variable in Formula (1) based on the position value estimation information FC1. The left side of Formula (1) is a value indicating the position value of the target data. For example, “x” in Formula (1) indicates data. In the example of FIG. 1, “x” indicates additional data as target data. Furthermore, for example, “D” in Formula (1) indicates prior knowledge. In the example of FIG. 1, “D” indicates a data set not including target data, that is, a data set (data set DS1) before addition of additional data.

The function “max ( )” on the right side of Formula (1) outputs a larger value out of the values in parentheses, namely, the first term “0” and the second term “d_{T}(M(D),y)−d_{T}(M({x}∪D),y)”. That is, the left side of Formula (1) will be obtained as a value of the second term when the accuracy is improved by adding the target data, while obtained as a value of the first term (that is, 0) when the accuracy is lowered by adding the target data.

In the second term of the function “max ( ), a subscript “T” in “d_{T}( )” indicates a task being an analysis target (predetermined task in FIG. 1). In addition, “d_{T}( )” in the second term indicates an evaluation function. The evaluation function “d_{T}( )” outputs a distance between the first term in parentheses and the second term, as an evaluation value. In the function “max( )”, “y” in the second term indicates ground truth information (ground truth label). For example, in FIG. 1, the ground truth information “y” may be “1”.

Note that the evaluation function “d_{T}( )” is merely an example, and the information processing system 1 may use various evaluation functions. For example, when the ground truth information cannot be acquired, the information processing system 1 may use an evaluation function that does not require ground truth information. In this case, the information processing system 1 may use an evaluation function that uses only accuracy in a predetermined task. Furthermore, the information processing system 1 may use accuracy in a predetermined task as an evaluation value.

“M(D)” indicates accuracy (first accuracy) in a predetermined task when a data set (first set) not including the target data is used. In addition, “d_{T}(M(D),y)” indicates evaluation (first evaluation) of the data set (first set) not including the target data. In FIG. 1, for example, “d_{T}(M(D),y)” indicates a distance between accuracy (0.7) in a predetermined task and ground truth information (for example, 1) when the data set DS1 not including the data D11 is used.

“M({x}∪D” indicates accuracy (second accuracy) in a predetermined task when a data set (second set) including the target data is used. In addition, “d_{T}(M({x}∪D),y))” indicates evaluation (second evaluation) of the data set (second set) including the target data. In FIG. 1, for example, “d_{T}(M({x}∪D),y))” indicates a distance between accuracy (0.8) in a predetermined task and ground truth information (for example, 1) when the data set DS11 including the data D11 is used.

The information processing system 1 estimates the position value of the data D11 being the additional data, by using the above Formula (1). For example, the information processing system 1 estimates that the position value of the data D11 is “0.1”.

Next, a case where another piece of data D21 is used as additional data will be briefly described. Note that description of similar points to those described above will be omitted as appropriate. The information processing system 1 adds the data D21 being additional data to the data set DS1 (step S21). Subsequently, the information processing system 1 derives accuracy for the data set DS2 obtained by adding the data D21 to the data set DS1. For example, using the analysis model M, the information processing system 1 predicts accuracy to be obtained when the data set DS21 is used for a predetermined task (step S22). FIG. 1 illustrates, as represented by accuracy information AC21, a case where the accuracy “0.72” is obtained when the data set DS2 including added data D21 is used for a predetermined task. For example, after inputting the data set DS2 to the analysis model M, the information processing system 1 predicts an output value “0.72” output from the analysis model M as the accuracy to be obtained when the data set DS2 is used for a predetermined task.

Subsequently, the information processing system 1 estimates the position value of the data D21 being the additional data (step S23). For example, the information processing system 1 estimates the position value of the data D21 being the additional data by using the accuracy “0.7” to be obtained when the data set DS1 is used for a predetermined task and using the accuracy “0.72” to be obtained when the data set DS2 is used for a predetermined task. Specifically, the information processing system 1 estimates the position value of the data D21 being the additional data, by using the above Formula (1). For example, the information processing system 1 estimates that the position value of the data D21 is “0.02”.

With the above-described processing, the information processing system 1 can appropriately estimate the value related to the position of the data. In addition, with the processing of estimating the position value as described above, the information processing system 1 can handle the values of the data of different types as position values in a standardized manner. Specifically, although there has been no index for fairly comparing the values as the position values of each piece of data regardless of types, the information processing system 1 can estimate the index (position value) for fair comparison regardless of types by using processing of estimating the position value as described above, making it possible to perform standardized handling of the values of the data of different types as position values. With this configuration, even when various types of data are mixed, the information processing system 1 can specify which data is important as the information regarding the position, achieving prioritization of individual pieces of data.

For example, in the example of FIG. 1, the position value of the data D11 is determined as “0.1”, and the position value of the data D21 is determined as “0.02”. In this case, regardless of the type of data of the data D11 and the data D21, the information processing system 1 can estimate that the value as the position is higher in the data D11 than the data D21 by comparing the position value of the data D11 with the position value of the data D21.

1-1. Target Data

The above-described example is the case of estimating the position value of data (additional data) to be newly added to the data set. However, the target data to be estimated for the position value is not limited to the additional data, and may be various types of data. For example, the target data may be one piece of data, or may be a data group including a plurality of pieces of data, that is, a data set. In this manner, the target data for which the position value is to be estimated may be any data. This point will be described below.

1-2. Data in Data Set

For example, the information processing system 1 may use the data that has been included in the data set (also referred to as “data constituting the set”) as the target data and may estimate the position value of the data (data constituting the set). In this case, the information processing system 1 estimates the position value using the data constituting the set, which is included in the data set, as target data. For example, the information processing system 1 estimates the position value of the target data by comparing a first evaluation of a first set being a data set with a second evaluation of a second set obtained by excluding the target data from the first set. When the data constituting the set, which has been included in the data set, is used as target data, the only difference from the case where additional data is determined as target data is whether “x” in the above Formula (1) is additional data or the data constituting the set, which is included in the data set.

Specifically, when this relationship is described with the above Formula (1), “{x}∪D” represents a data set including the target data, that is, a data set (first set) before exclusion of the target data. In addition, “D” represents a data set not including the target data, that is, a data set (second set) after exclusion of the target data. Since the other points are the same as the estimation of the position value of additional data described above, the detailed description thereof will be omitted. Note that the information processing system 1 may use a mathematical expression other than the above (1). For example, the information processing system 1 may use a mathematical expression (also referred to as a “second mathematical expression”) in which the data set before excluding the data constituting the set (that is, the data set including the data constituting the set) is represented by “D” and the second term in parentheses of the function “max( )” on the right side of Formula (1) is replaced with “d_{T}(M(D−x),y)−d_{T}(M(D),y)”.

1-3. Data Set

Furthermore, for example, the information processing system 1 may estimate the position value of the data set using the entire data set as target data. In this case, the information processing system 1 estimates the position value using the entire data set as the target data. For example, the information processing system 1 may estimate the position value of the data set based on a change in evaluation of the data set due to a change in the data set by operations such as adding data to the data set or excluding data from the data set. Although the following will describe a case of estimating the value of the data set using the above Formula (1) as an example, the information processing system 1 may estimate the position value using the data set as the target data using a mathematical expression for estimating the position value of a data set different from the above Formula (1).

1-3-1. Estimation by Addition of Data

The information processing system 1 may estimate the position value of the data set based on a change in evaluation of the data set by adding data to the data set. For example, the information processing system 1 acquires additional data to be added to the data set, and estimates the position value of the data set by comparing the first evaluation of the first set which is the data set with the second evaluation of the second set obtained by adding the additional data to the first set.

In this manner, the only difference between the case where entire data set is set as the target data and the case where the additional data is set as the target data is whether the output value of the above Formula (1) is used as the position value of the entire data set or used as the position value of the additional data. Since this is the same as the estimation of the position value of additional data described above, the detailed description thereof will be omitted.

Note that, when the above Formula (1) is used for estimating the position value of the data set obtained by adding data to the data set, the larger the output value of the above Formula (1), the higher the accuracy as the data set by addition of new data, that is, indicating that the existing data of the data set is insufficient. Accordingly, when the above Formula (1) is used for estimating the position value of the data set obtained by adding data to the data set, the smaller the output value of the above Formula (1), the higher the position value of the data set.

In addition, when using the above-described Formula (1), estimation is influenced by the position value of the additional data itself. In view of this, when using a data set as target data, it is allowable to perform the processing of estimating the position value with additional data a plurality of times and to use an average value of the plurality of operations as the position value of the data set. For example, the information processing system 1 may add each of a plurality of pieces of randomly selected data to the data set as additional data, repeat processing of estimating the position value by the number of the plurality of pieces of data, and may estimate the average of the estimated position values as the position value of the data set.

1-3-2. Estimation by Data Exclusion

The information processing system 1 may estimate the position value of the data set based on a change in evaluation of the data set by excluding data from the data set. For example, the information processing system 1 estimates the position value of the first set with the first set as the target data by comparing the first evaluation of the first set as the data set with the second evaluation of the second set obtained by excluding predetermined data from the first set. As compared with the above-described case where the additional data is determined as the target data, the case where position value of the data set is estimated by excluding data from the data set in this manner uses Formula (1) in which “{x}∪D” is a data set (first set) before data exclusion. In addition, “D” is a data set (second set) after data exclusion.

Note that, when the above Formula (1) is used for estimating the position value of the data set by excluding data from the data set, the larger the output value of the above Formula (1), the higher the value of the existing data included in the data set. Accordingly, when the above Formula (1) is used for estimating the position value of the data set obtained by excluding data from the data set, the larger the output value of the above Formula (1), the higher the position value of the data set.

In addition, when using the above-described Formula (1), estimation is influenced by the position value of the excluded data. In view of this, when using a data set as target data, it is allowable to perform the processing of estimating the position value on a plurality of pieces of data within the data set and to use an average value of the plurality of pieces of data as the position value of the data set. For example, the information processing system 1 may exclude each of a plurality of pieces of randomly selected data from the data set, repeat processing of estimating the position value by the number of the plurality of pieces of data, and may estimate the average of the estimated position values as the position value of the data set. For example, the information processing system 1 may repeat processing of excluding each piece of all data included in the data set from the data set and estimating the position value, and may estimate an average of the estimated position values as the position value of the data set. Note that the information processing system 1 may use the second mathematical expression described above to estimate the position value of the data set based on a change in the evaluation of the data set caused by excluding the data from the data set.

Note that the estimation of the position value described above is merely an example, and the information processing system 1 may estimate the position value of various types of data as target data using various types of information and various mathematical expressions.

1-4. Configuration of Information Processing System

Next, a configuration of the information processing system 1 will be described with reference to FIG. 2. FIG. 2 is a diagram illustrating an example of an information processing system 1 according to the embodiment. As illustrated in FIG. 2, the information processing system 1 includes a terminal device 10 and a server device 50. The terminal device 10 and the server device 50 are communicably connected to each other using a wired or wireless channel via a predetermined network N. Note that the information processing system 1 illustrated in FIG. 2 may include a plurality of terminal devices 10 and a plurality of server devices 50.

The terminal device 10 is actualized by, for example, a smartphone, a tablet terminal, a notebook personal computer (PC), a desktop PC, a mobile phone, a personal digital assistant (PDA), or the like. Note that the terminal device 10 may be described as a user. That is, the user can be rephrased as the terminal device 10.

Furthermore, the terminal device 10 is assumed to have a function such as a GPS sensor, and assumed to be able to detect and acquire the position of the user. Furthermore, the terminal device 10 may detect and acquire the position information of the user by using position information of a base station being used for communication, a predetermined wireless communication function such as Wireless-Fidelity (Wi-Fi, registered trademark) or Bluetooth (registered trademark), or a function such as a beacon. Note that the position information will be simply referred to as a “position” in some cases. For example, the terminal device 10 may improve the estimation accuracy of the position of the user by combining information such as a GPS, a wireless communication function as described above, a beacon, and the like.

The terminal device 10 collects the user's action in association with user's position at a point of the action. The terminal device 10 collects the user's action using the terminal device 10 in association with the user position at the point of the action. The terminal device 10 collects the action related to the user operation of the terminal device 10 in association with the user position at the point of the action.

Furthermore, the terminal device 10 may detect various types of sensor information not only by a GPS sensor or the like but also by various sensors. The terminal device 10 transmits various sensor information detected by the sensor to an information processing device 100. The terminal device 10 includes an acceleration sensor, and detects acceleration information (sensor information) in movement of the user. The terminal device 10 includes an image sensor, and detects image information (sensor information) of the user. The terminal device 10 includes a sound sensor such as a microphone and detects voice information (sensor information). Furthermore, the terminal device 10 may have various functions such as a temperature sensor and an atmospheric pressure sensor, and may be capable of detecting and acquiring user's environmental information such as temperature and atmospheric pressure. For example, the user who uses the terminal device 10 may use a wearable device capable of communicating with the terminal device 10 so as to be able to acquire context information regarding the user by the terminal device 10. For example, the terminal device 10 includes various sensors and detects various types of sensor information. For example, the user who uses the terminal device 10 may wear a wristband-type wearable device capable of communicating with the terminal device 10 so that the terminal device 10 can acquire information regarding the user's own heart rate (pulse) by the terminal device 10. Furthermore, the terminal device 10 may have various functions such as a blood glucose level sensor and a heart rate sensor, and may be capable of detecting and acquiring biological information (sensor information) such as a blood glucose level (blood glucose level information) and a heart rate (heart rate information) of the user. The terminal device 10 collects the sensor information detected by the terminal device 10 in association with the position at the point of detection of the sensor information.

The server device 50 is an information processing device that provides various services to a user who uses the terminal device 10. For example, the server device 50 may be a service providing device that provides content such as articles and advertisements to the terminal device 10. The server device 50 may manage the data received from the terminal device 10 in association with the user who uses the terminal device 10. Then, the server device 50 may perform a content providing service for the user by using the data received from the terminal device 10.

1-4-1. Other System Configuration Examples

The above example is a case where the terminal device 10 is the information processing device that performs the value estimation processing. However, a device that collects data including a position (for example, the terminal device 10) and the information processing device that performs the value estimation processing may be separate from each other. For example, the terminal device 10 may be an information processing device that transmits data including the collected position to the server device 50 and performs estimation processing of estimating the position value of the data including the position received by the server device 50 from the terminal device 10.

2. Configuration of Terminal Device

Next, a configuration of the terminal device 10 according to the embodiment will be described with reference to FIG. 3. FIG. 3 is a diagram illustrating a configuration example of a terminal device according to the embodiment. As illustrated in FIG. 3, the terminal device 10 includes a communication unit 11, an input unit 12, a display unit 13, a storage unit 14, a control unit 15, and a sensor unit 16. Although not illustrated, the terminal device 10 includes a voice output unit such as a speaker that outputs voice. For example, the voice output unit outputs a voice corresponding to information displayed on the display unit 13. Furthermore, the terminal device 10 may include a voice input unit represented by a microphone, and may receive an input from a user by voice.

Communication Unit 11

The communication unit 11 is actualized by, for example, a communication circuit or the like. Then, the communication unit 11 is connected to a predetermined communication network (not illustrated) using a wired or wireless channel, and exchanges information with an external information processing device. For example, the communication unit 11 is connected to a predetermined communication network (not illustrated) using a wired or wireless channel, and exchanges information with the server device 50.

Input Unit 12

The input unit 12 receives an input of various operations from the user. For example, the input unit 12 may receive various operations from the user via a display surface (for example, the display unit 13) by a touch panel function. Furthermore, the input unit 12 may receive various operations from a button provided on the terminal device 10 or a keyboard or a mouse connected to the terminal device 10.

The input unit 12 receives various operations from the user via a display screen of a tablet terminal or the like by a touch panel function implemented by various sensors included in the sensor unit 16. That is, the input unit 12 receives various operations from the user via the display unit 13 of the terminal device 10. For example, the input unit 12 receives an operation such as a designation operation by the user via the display unit 13 of the terminal device 10. In other words, the input unit 12 functions as a reception unit that receives user's operations by the touch panel function. Although the method of detecting the user's operation by the input unit 12 is represented by a capacitance method mainly adopted in the tablet terminal, it is allowable to adopt any other detecting method such as a resistive film method, a surface acoustic wave method, an infrared method, and an electromagnetic induction method, as long as the method is capable of detecting the user's operation and implementing the touch panel function. Furthermore, in a case where a button is provided on the terminal device 10 or a keyboard or a mouse is connected to the terminal device 10, the terminal device 10 may have an input unit that also receives an operation using a button or the like.

Display Unit 13

The display unit 13 is a display screen of a tablet terminal or the like, actualized by a liquid crystal display, an organic electro-luminescence (EL) display, for example, and is a display device for displaying various types of information. That is, the terminal device 10 receives an input from the user by using the display screen being the display unit 13, and also performs output to the user.

Storage Unit 14

The storage unit 14 is actualized by a semiconductor memory element such as random access memory (RAM) and flash memory, or by a storage device such as a hard disk or an optical disk. The storage unit 14 stores, for example, information regarding an application (for example, a content display application) installed in the terminal device 10, for example, a program or the like.

Furthermore, as illustrated in FIG. 3, the storage unit 14 according to the embodiment includes a value estimation information storage unit 141. Although not illustrated in detail, the value estimation information storage unit 141 stores various types of information necessary for estimating the value of data, such as a model (function) for predicting the accuracy of the data set and mathematical expressions for estimating the position value as indicated in the above Formula (1).

Note that the above is merely an example, and the storage unit 14 stores various types of information. The storage unit 14 stores a data set in which each data includes information regarding a position. The storage unit 14 stores data in which the user's action is associated with the user's position at the point of the action. The storage unit 14 stores data in which the user's action using the terminal device 10 is associated with the user's position at the point of the action. The storage unit 14 stores data in which an action related to the user's operation of the terminal device 10 is associated with a position at the point of the action. The storage unit 14 stores data in which the sensor information detected by the terminal device 10 is associated with the position at the point of detection of sensor information.

Control Unit 15

The control unit 15 is a controller and is actualized by execution of various programs stored in a storage device such as the storage unit 14 inside the terminal device 10 by a central processing unit (CPU), a micro processing unit (MPU), or the like, by using RAM as a work area. For example, the various programs include a program of an application (for example, a home application) that performs information processing. Furthermore, the control unit 15 is a controller and is actualized by an integrated circuit such as an application specific integrated circuit (ASIC) or a field programmable gate array (FPGA), for example.

As illustrated in FIG. 3, the control unit 15 includes an acquisition unit 151, an estimation unit 152, a decision unit 153, and a transmission unit 154, and implements or executes a function and an action of information processing described below. The internal configuration of the control unit 15 is not limited to the configuration illustrated in FIG. 3, and may be any other configuration as long as it performs information processing described below. Furthermore, the connection relationship of each processing unit included in the control unit 15 is not limited to the connection relationship illustrated in FIG. 3, and may be other connection relationships.

Acquisition Unit 151

The acquisition unit 151 acquires various types of information. For example, the acquisition unit 151 acquires various types of information from an external information processing device. For example, the acquisition unit 151 acquires various types of information from the storage unit 14. The acquisition unit 151 acquires various types of information from a value estimation information storage unit 141. For example, the acquisition unit 151 acquires sensor information detected by the sensor unit 16.

The acquisition unit 151 collects various types of information. The acquisition unit 151 collects an action log of the user of the terminal device 10. The acquisition unit 151 collects sensor information detected by the sensor unit 16.

The acquisition unit 151 collects the user's action in association with the user's position at the point of the action. The acquisition unit 151 collects the user's action using the terminal device 10 in association with the user's position at the point of the action. The acquisition unit 151 collects the user's action related to the operation of the terminal device 10 in association with the user's position at the point of the action. The acquisition unit 151 collects the sensor information detected by the terminal device 10 in association with the position at the point of detection of the sensor information. For example, the acquisition unit 151 stores the collected various types of information in the storage unit 14.

The acquisition unit 151 acquires a data set in which each data includes information regarding a position. The acquisition unit 151 acquires a data set related to the user's action. The acquisition unit 151 acquires target data. The acquisition unit 151 acquires additional data to be added to the data set. The acquisition unit 151 acquires a data set in which each data includes information regarding a position. The acquisition unit 151 acquires addition candidate data as a candidate for new addition to the data set. The acquisition unit 151 acquires, from the server device 50 being an external device, external estimation data used for estimating a position value indicating a value related to a position of target data.

Estimation Unit 152

The estimation unit 152 executes estimation processing of estimating various types of information. For example, the estimation unit 152 executes estimation processing based on various types of information acquired by the acquisition unit 151. For example, the estimation unit 152 executes estimation processing based on the information stored in the storage unit 14. For example, the estimation unit 152 executes estimation processing based on sensor information detected by the sensor unit 16. For example, the estimation unit 152 executes estimation processing based on the position information detected by the sensor unit 16.

The estimation unit 152 executes calculation processing of calculating an evaluation value (score) regarding data. The estimation unit 152 calculates an evaluation value of the data set. The terminal device 10 calculates a first evaluation in a predetermined task to be obtained when the data set is used. The terminal device 10 calculates a second evaluation in a predetermined task to be obtained when the addition candidate data is added to the data set.

The estimation unit 152 estimates a value of the data. The estimation unit 152 estimates a value (position value) related to the position of data. The estimation unit 152 estimates the position value of the addition candidate data by using the first evaluation and the second evaluation.

The estimation unit 152 estimates the position value of the target data based on the evaluation of each of the data sets including mutually different data in the predetermined task. By using the first evaluation that is the evaluation in the predetermined task to be obtained when the first set based on the data set is used and by using the second evaluation that is the evaluation in the predetermined task to be obtained when the second set based on the data set and different from the first set is used, the estimation unit 152 estimates the position value indicating the value related to the position of the target data that is the data to be the target of value estimation. By comparing the first evaluation of the first set with the second evaluation of the second set, the estimation unit 152 estimates the position value of the target data. The estimation unit 152 estimates the position value of the target data based on a difference between the first evaluation of the first set and the second evaluation of the second set.

The estimation unit 152 estimates the position value of the target data based on the first evaluation, which is a difference between the first accuracy being the accuracy obtained when the first set is used for a predetermined task and ground truth accuracy being the ground truth for the predetermined task and based on the second evaluation, which is a difference between the second accuracy being the accuracy obtained when the second set is used for the predetermined task and the ground truth accuracy. The estimation unit 152 estimates the position value of the target data based on the first evaluation and the second evaluation in a predetermined task related to the service using the position. The estimation unit 152 estimates the position value of the target data based on the first evaluation and the second evaluation in a predetermined task related to the position of the user.

The estimation unit 152 estimates a position value of target data that is data not included in the data set. The estimation unit 152 estimates the position value of the target data by comparing the first evaluation of a first set that is a data set with a second evaluation of a second set obtained by adding the target data to the first set. The estimation unit 152 estimates the position value of the target data, which is data included in the data set.

The estimation unit 152 estimates the position value of the target data by comparing a first evaluation of a first set that is a data set with a second evaluation of a second set obtained by excluding the target data from the first set. The estimation unit 152 compares the first evaluation of the first set as the data set with the second evaluation of the second set obtained by adding the additional data to the first set, thereby estimating the position value of the first set by defining the first set as the target data. By comparing the first evaluation of the first set as the data set with the second evaluation of the second set obtained by excluding predetermined data from the first set, the estimation unit 152 estimates the position value of the first set by defining the first set as the target data.

The estimation unit 152 estimates the position value of the target data using external estimation data. The estimation unit 152 estimates the position value of the target data based on the acquisition data acquired by the acquisition unit 151 and the external estimation data.

Decision Unit 153

The decision unit 153 executes decision processing for deciding various types of information. For example, the decision unit 153 executes decision processing based on various types of information acquired by the acquisition unit 151. For example, the decision unit 153 executes decision processing based on the information stored in the storage unit 14. For example, the decision unit 153 executes decision processing based on the sensor information detected by the sensor unit 16. For example, the decision unit 153 executes decision processing based on the estimation result obtained by the estimation unit 152.

The decision unit 153 executes determination processing. The decision unit 153 determines whether the position value of the addition candidate data is a threshold or more. When the position value of the addition candidate data is the threshold or more, the decision unit 153 decides to add the addition candidate data to the data set. When the position value of the addition candidate data is not the threshold or more, the decision unit 153 decides not to add the addition candidate data to the data set.

The decision unit 153 decides whether to transmit the target data to the server device 50 based on the position value of the target data estimated by the estimation unit 152. When the position value is a predetermined value or more, the decision unit 153 decides to transmit the target data to the server device 50. The decision unit 153 decides whether to transmit the target data to the server device 50 according to an instruction of the user who has presented the position value. When the user instructs to transmit the target data to the server device 50, the decision unit 153 decides to transmit the target data to the server device 50.

The decision unit 153 decides whether to transmit the target data to the server device 50 being an external device based on a non-transmission index to be set based on an instruction of the user. The decision unit 153 decides whether to transmit the target data to the server device 50 based on the position value of the target data estimated by the estimation unit 152 and the non-transmission index.

Transmission Unit 154

The transmission unit 154 transmits various types of information to an external information processing device via the communication unit 11. The transmission unit 154 transmits various types of information to the server device 50. The transmission unit 154 transmits various types of information stored in the storage unit 14 to the external information processing device. The transmission unit 154 transmits the various types of information acquired by the acquisition unit 151 to the external information processing device.

The transmission unit 154 transmits data to an external device according to the decision made by the decision unit 153. When the decision unit 153 decides to transmit data to the external device, the transmission unit 154 transmits the data to the external device. When the decision unit 153 decides to transmit data to the external device, the transmission unit 154 transmits the data to the server device 50.

For example, when the decision unit 153 has decided to transmit data to the external device, the transmission unit 154 transmits addition candidate data to the external device. When the decision unit 153 has decided not to transmit data to the external device, the transmission unit 154 does not transmit the addition candidate data to the external device.

The transmission unit 154 transmits the target data to the server device 50 according to the decision made by the decision unit 153. When the decision unit 153 has decided to transmit the target data to the server device 50, the transmission unit 154 transmits the target data to the server device 50.

Note that each processing performed by the control unit 15 described above may be implemented by JavaScript (registered trademark), for example. Furthermore, when the processing such as information processing of the control unit 15 described above is performed by a predetermined application, each unit of the control unit 15 may be implemented by the predetermined application, for example. For example, processing such as information processing of the control unit 15 may be implemented by control information received from an external information processing device.

Sensor Unit 16

The sensor unit 16 detects predetermined information. Note that the sensor unit 16 may include various sensors for detecting information used for information processing.

The sensor unit 16 includes a sensor (position sensor) that detects the position of the terminal device 10. For example, the sensor unit 16 may include a GPS sensor. Furthermore, when acquiring position information of the terminal device 10 as sensor information, the sensor unit 16 may acquire the position information of a base station performing communication or the position information of the terminal device 10 estimated using radio waves of WiFi (registered trademark).

Furthermore, the sensor unit 16 is not limited to the above, and may include various sensors. For example, the sensor unit 16 may include a sensor that detects information outside the terminal device 10.

For example, the sensor unit 16 includes an acceleration sensor. For example, the sensor unit 16 includes a sensor that detects acceleration information of the terminal device 10 at the time of a predetermined operation performed by the user. For example, the sensor unit 16 includes a sensor, a timer, or the like that detects a user's contact with the screen of the terminal device 10. For example, the sensor unit 16 includes a sensor used to detect time information indicating a period of time from a point at which the user touches the screen of the terminal device 10 to a time at which the contact is released.

For example, the sensor unit 16 includes a sensor that detects various types of information regarding a user's operation on the terminal device 10. For example, the sensor unit 16 includes a pressure sensor. For example, the sensor unit 16 includes a sensor that detects pressure information indicating the pressure at which the user comes into contact with the screen. For example, the sensor unit 16 includes a sensor that detects a contact range (coordinates) of the user on the screen. For example, the sensor unit 16 includes a sensor that detects position information indicating a position on the screen at which the user comes in contact. For example, the sensor unit 16 includes a sensor that detects area information indicating an area on the screen in which the user comes in contact.

For example, in a case where image information captured by a camera function is used for information processing, the sensor unit 16 may include a camera (image sensor). For example, the sensor unit 16 includes an image sensor in order to capture an image of the user. For example, the sensor unit 16 includes an in-camera or an out-camera that functions as an image sensor. The sensor unit 16 includes an in-camera and captures an image of a user who operates while viewing a screen.

Note that the sensors that detect the various types of information in the sensor unit 16 may be an integrated sensor or may be implemented by separate sensors.

3. Flow of Information Processing

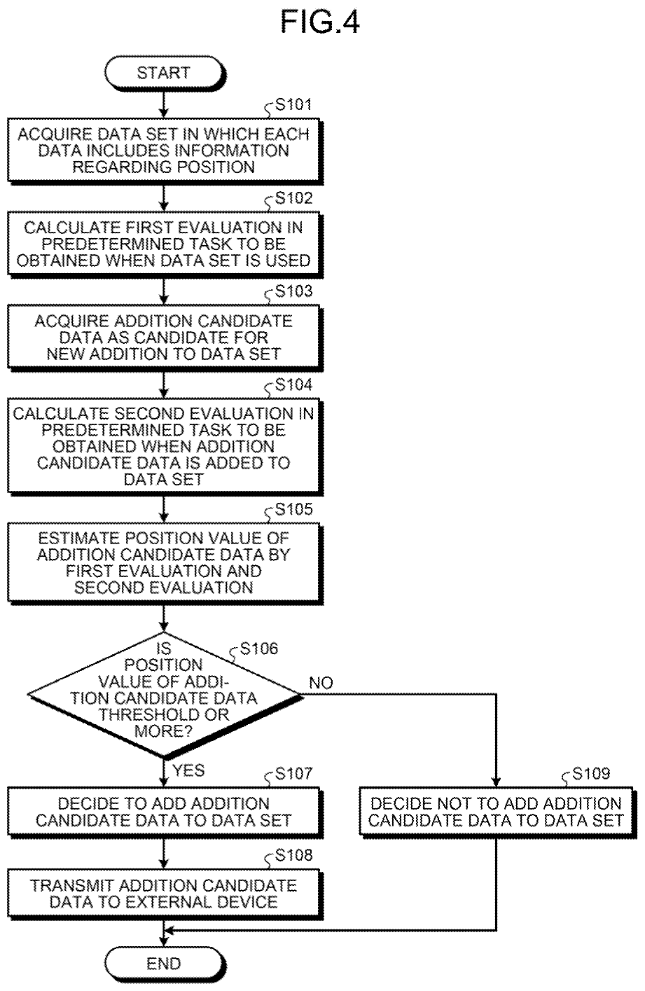

Next, a procedure of information processing according to the embodiment will be described with reference to FIG. 4. FIG. 4 is a flowchart illustrating an example of information processing according to the embodiment.

As illustrated in FIG. 4, the terminal device 10 acquires a data set in which each data includes information regarding a position (step S101). Subsequently, the terminal device 10 calculates a first evaluation in a predetermined task to be obtained when the data set is used (step S102).

The terminal device 10 acquires addition candidate data that is a candidate of data to be newly added to the data set (step S103). The terminal device 10 calculates a second evaluation in a predetermined task to be obtained when the addition candidate data is added to the data set (step S104).

The terminal device 10 estimates the position value of the addition candidate data by the first evaluation and the second evaluation (step S105). The terminal device 10 determines whether the position value of the addition candidate data is a threshold or more (step S106).

When the position value of the addition candidate data is the threshold or more (step S106: Yes), the terminal device 10 decides to add the addition candidate data to the data set (step S107). The terminal device 10 then transmits the addition candidate data to the external device (step S108).

In contrast, when the position value of the addition candidate data is not the threshold or more (step S106: No), the terminal device 10 decides not to add the addition candidate data to the data set (step S109). The terminal device 10 then ends the process without transmitting the addition candidate data to the external device.

4. Example of Information Processing

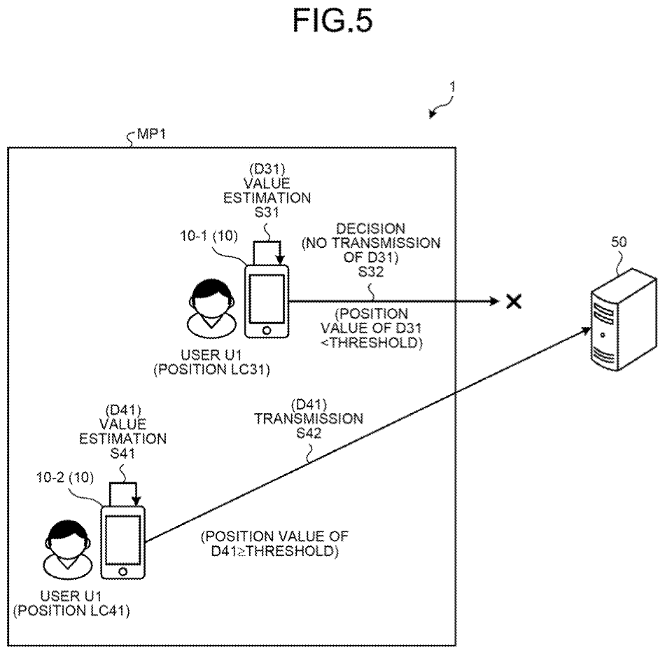

Here, an example of processing in the information processing system 1 including data transmission decision processing and the like will be described with reference to FIG. 5. FIG. 5 is a diagram illustrating an example of processing in the information processing system 1 according to the embodiment. FIG. 5 illustrates a case where the terminal device 10 is a smartphone used by a user U1. When the user is described as “user U* (* is a certain numerical value)” as above, the user is a user identified by the user ID “U*”. For example, when the user is described as “user U1”, the user is a user identified by the user ID “U1”.

FIG. 5 illustrates a case of estimating the position value of individual positions of the user U1 for each data collected at the positions and making a decision whether to transmit the data to the server device 50 according to the position value. FIG. 5 is a drawing in which the position of the user U1 is schematically illustrated using a map MP1 and the terminal device 10 is described as a terminal device 10-1 and a terminal device 10-2 in accordance with the change of the position of the user U1. Note that the terminal device 10-1 and the terminal device 10-2 are the identical terminal device 10. Furthermore, in the following, the terminal device 10-1 and the terminal device 10-2 will be referred to as the terminal device 10 when they are not particularly distinguished from each other.

First, the terminal device 10-1 estimates the position value of data D31 collected for the user U1 located at a position LC31 (step S31). For example, the terminal device 10-1 collects the data D31 related to an application (for example, a route search application) used by the user U1 at the position LC31, and estimates the position value of the collected data D31.

Subsequently, the terminal device 10-1 decides whether to transmit the data D31 to the server device 50 using the estimated position value of the data D31 (step S32). In the example of FIG. 5, since the estimated position value of the data D31 is less than a threshold, the terminal device 10-1 decides not to transmit the data D31 to the server device 50.

Next, the terminal device 10-2 estimates the position value of data D41 collected for the user U1 located at a position LC41 (step S41). For example, the terminal device 10-2 collects the data D41 related to an application (for example, SNS application) used by the user U1 at the position LC41, and estimates the position value of the collected data D41.

Subsequently, the terminal device 10-2 decides to transmit the data D41 to the server device 50 based on the estimated position value of the data D41, and transmits the data D41 to the server device 50 (step S42). In the example of FIG. 5, since the estimated position value of the data D41 is the threshold or more, the terminal device 10-2 decides to transmit the data D41 to the server device 50. Subsequently, the terminal device 10-2 transmits the data D41 having a position value being the threshold or more to the server device 50.

In this manner, the terminal device 10 decides whether to transmit the collected data to the server device 50 based on the position value of the data. In this manner, by deciding whether to transmit the target data to the server device 50 based on the position value of the target data, the terminal device 10 can appropriately decide which data is to be transmitted to the server device 50 according to the value related to the position of the data. This makes it possible for the information processing device to suppress transmission of unnecessary data to the server device 50, leading to suppression of an increase in the amount of data communication with the server device 50.

4-1. User Instruction

Note that the terminal device 10 may present the estimated position value to the user U1 and decide whether to transmit the target data to the server device 50 according to an instruction of the user U1. The terminal device 10 may display the information indicating the estimated position value, and decide whether to transmit the target data to the server device 50 according to an instruction of the user U1 who has confirmed the displayed position value. In this case, when the user U1 has instructed to transmit the data D31 to the server device 50, the terminal device 10 decides to transmit the data D31 to the server device 50.

4-2. Setting of Non-Transmission Index

The terminal device 10 may be configured such that the non-transmission index can be set in advance based on the instruction of the user, and decide whether to transmit the target data to the server device 50 based on the set non-transmission index. The non-transmission index is set based on evaluation for a predetermined task, for example. Alternatively, the non-transmission index may be set for the position of the target data.

When setting the non-transmission index based on the evaluation in a predetermined task, for example, the user performs the setting, onto the non-transmission index, that data by which the position of the user's home is likely to be estimated in the evaluation for a predetermined task is not going to be transmitted to the server device 50. The non-transmission index setting is performed based on the setting display of the non-transmission index displayed on the display unit 13 of the terminal device 10. The user operates the terminal device 10 based on the setting display of the non-transmission index, thereby setting a task for setting the non-transmission index and the non-transmission index for the task. In other words, the non-transmission index used in this manner is set as a threshold as to whether the task has a position value that can be used to estimate a certain position set by the user.

For example, when the task to which the non-transmission index is to be set is a task capable of estimating the commuting route of the user, the terminal device 10 confirms the user with a message such as “Agree to transmit position information indicating your personal commuting route to the outside?”. When the user does not want to reveal the personal commuting route, the user selects “No transmission of position information indicating personal commuting route to the outside” in response to the confirmation. With this operation, for the task capable of estimating the commuting route of the user, position information that indicates the commuting route of the user is set as the non-transmission index.

In another case, when the task to which the non-transmission index is to be set is a task capable of estimating the workplace of the user, the terminal device 10 confirms the user with a message such as “Agree to transmit position information indicating your workplace to the outside?”. In consideration of the usability of the terminal device 10 and the task and the degree of information regarding the workplace, the user sets a range of information regarding the workplace which the user agrees to be known to the outside. With this setting, in the task capable of estimating the workplace of the user, the position information is appropriately set as the non-transmission index according to the range set by the user. In this manner, since the non-transmission index can be set for each task, the task and the non-transmission index can be handled as a set, and the task and the non-transmission index are stored in the terminal device 10 in combination.

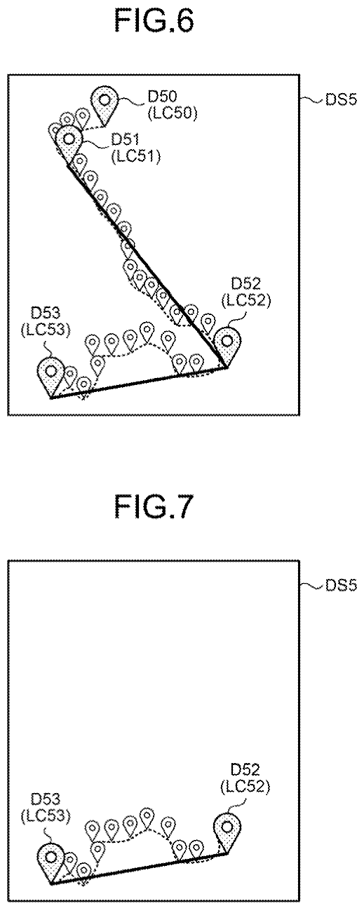

FIG. 6 is a diagram illustrating a data set for which suitability of transmission to the server device 50 is determined by setting a non-transmission index. FIG. 7 is a diagram illustrating a data set transmitted to the server device 50. In FIG. 6, the data set DS5 includes data D50, D51, D52, and D53. The data D50 is data representing the position of the user's home, and the data D51 is data representing the nearest station from the user's home. The data D52 is data representing a station near the workplace used by the user during commuting, and the data D53 is data representing a position of the workplace of the user. Each of the data D50, D51, D52, and D53 includes position information LC50, LC51, LC52, and LC53, respectively.

For example, it is assumed that the predetermined task is a task capable of estimating the user's commuting route, such as a route search application, and that the non-transmission index is set such that data capable of estimating the user's home position in the task capable of estimating the user's commuting route is not to be transmitted to the server device 50. In a case where it is determined that the position of the user's home can be estimated the data D50 and D51 by evaluating the position value by the estimation unit 152 using the data D50, D51, D52, and D53 included in the data set DS5 as the target data, the decision unit 153 decides not to transmit the data D50 or D51 to the server device 50. That is, when the data D50 and D51 are determined to satisfy the non-transmission index set by the user, the decision unit 153 decides not to transmit the data D50 or D51 to the server device 50 and decides not to add the data D50 or D51 to the data set DS5.

In this case, the transmission unit 154 that transmits the target data to the server device 50 according to the decision by the decision unit 153 transmits the data D52 and D53 without transmitting the data D50 or D51 in the data set DS5 as illustrated in FIG. 7.

4-3. Flow of Information Processing when Setting Non-Transmission Index

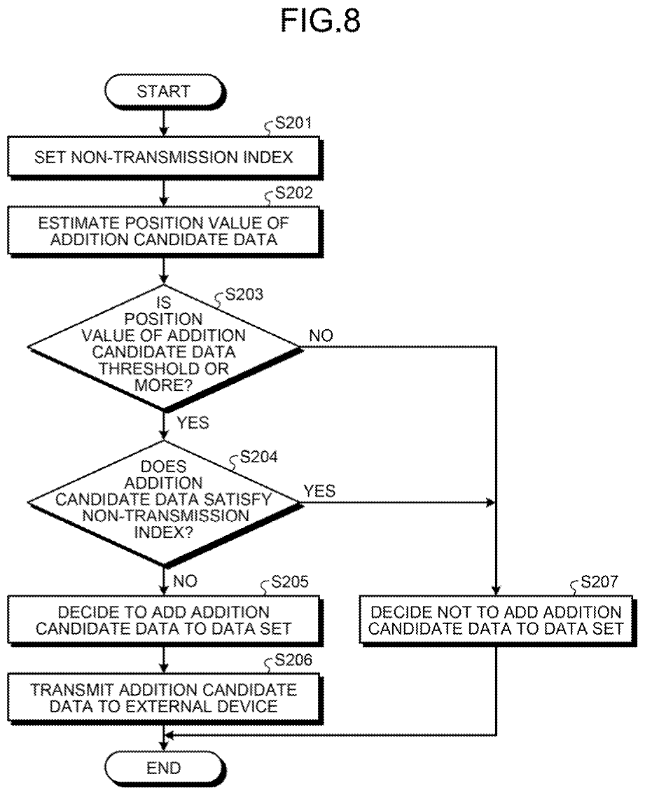

Next, an example of a procedure of information processing when setting a non-transmission index will be described with reference to FIG. 8. FIG. 8 is a flowchart illustrating an example of information processing according to the embodiment.

The user sets a non-transmission index using the terminal device 10 (step S201). In the setting of the non-transmission index, it is allowable to perform the setting for a task to which the non-transmission index is to be set together with the setting of the non-transmission index in the task, and is also allowable to perform the setting as an absolute non-transmission index applicable to any task.

The terminal device 10 acquires addition candidate data that is a candidate of data to be newly added to the data set and estimates a position value of the addition candidate data (step S202). The terminal device 10 determines whether the position value of the addition candidate data is a threshold or more (step S203). That is, the addition candidate data is determined whether the position value is the threshold or more by the first evaluation and the second evaluation described above.

When the position value of the addition candidate data is the threshold or more (step S203: Yes), the terminal device 10 determines whether the addition candidate data satisfies the non-transmission index (step S204). That is, the non-transmission index is set as a threshold as to whether the data including the position information has a position value usable for estimation of a certain position set by the user, and thus, the terminal device 10 determines whether the position value of the addition candidate data is the threshold set by the non-transmission index, or more.

When the addition candidate data does not satisfy the non-transmission index (step S204: No), that is, when the position value of the addition candidate data is less than the threshold set by the non-transmission index, the terminal device 10 decides to add the addition candidate data to the data set (step S205). Subsequently, the terminal device 10 transmits the addition candidate data to the external device (step S206).

In contrast, when the position value of the addition candidate data is not the threshold or more (step S203: No), the terminal device 10 decides not to add the addition candidate data to the data set (step S207). Moreover, even when the position value of the addition candidate data is the threshold or more, when the addition candidate data satisfies the non-transmission index (step S204: Yes), that is, when the position value of the addition candidate data is the threshold set by the non-transmission index, or more, the terminal device 10 decides not to add the addition candidate data to the data set (step S207). In these cases, the terminal device 10 ends the processing without transmitting the addition candidate data to the external device.

4-4. Other Examples of Non-Transmission Index

The non-transmission index may be set for the position of the target data regardless of the task. That is, it is allowable to have a configuration in which the non-transmission index is set to the position of certain target data, thereby deciding that the position information of the target data to which the non-transmission index has been set, or the target data, is not to be transmitted to the external device in all the tasks. In this case, the position information might be required depending on the task. However, it would be preferable to confirm to the user the suitability of transmitting the position information regarding the target data to which the non-transmission index has been set, each time the position information is required.

For example, when the user does not want to transmit the data of the user's home position, the user operates the terminal device 10 to set the non-transmission index so as not to transmit the target data including the home position information to the external device. In this case, the user's home position information is not to be transmitted to the external device regardless of the task to be executed. Here, there is a case where the position information needs to be transmitted to an external device depending on the task. However, in this case, it is preferable to confirm with the user whether to transmit the position information regarding the user's home to the external device or stop the execution of the task each time the transmission is performed.

4-5. External Estimation Data

When estimating the position value of the target data, the terminal device 10 may acquire external estimation data used for estimating the position value of the target data from an external device and estimate the position value using the acquired external estimation data. In this case, the external estimation data is defined as a position value estimation model capable of estimating how much certain position information is valuable in a predetermined task based on a large amount of past position information acquired by an external device.

Since an external device has acquired a large amount of position information from a large number of terminal devices, the external device learns a position value for a predetermined task for each position information based on the large amount of position information acquired in the past, and creates and stores beforehand a model that has generalized the position value of the position information for the predetermined task. When estimating the position value of the target data, the terminal device 10 may acquire, from an external device, external estimation data being a model for estimating the position value stored in the external device in this manner, and may use the external estimation data for estimating the position value.

That is, when the position information is acquired by the terminal device 10, it may be difficult for the terminal device 10 alone to estimate the position value in a predetermined task. For example, if the position value of the data in a predetermined task can be estimated based on the position information of the data in a short period of time, the position value can be estimated using the data stored in the terminal device 10. However, when estimating the position value based on position information of the medium or long term data, it would be difficult to estimate the position value only with the data stored in the terminal device 10 in some cases. In this case, the terminal device 10 acquires external estimation data from an external device and estimates the position value using the acquired external estimation data.

Specifically, when estimation of the position value of the target data in a predetermined task is difficult by the terminal device 10 alone, the acquisition unit 151 of the terminal device 10 acquires external estimation data, which is a model used for estimating the position value of the target data, from the server device 50 being an external device. The estimation unit 152 of the terminal device 10 estimates the position value of the target data using the external estimation data. That is, the estimation unit 152 estimates the position value of the target data in the predetermined task by applying the position information of the target data to the external estimation data.

At that time, when the acquisition unit 151 has acquired acquisition data different from the target data, the estimation unit 152 may estimate the position value of the target data based on the acquisition data and the external estimation data. The acquisition data in this case is data including position information, and the position information of the acquisition data may indicate the same position as the target data or the position different from the target data. After the position value of the target data is estimated by the estimation unit 152, the decision unit 153 decides whether to transmit the target data to the server device 50 based on the position value of the target data estimated by the estimation unit 152 and the non-transmission index that is set based on the instruction of the user.

With this configuration, even when it is difficult to estimate the position value of the target data in a predetermined task by the terminal device 10 alone, it is possible to decide whether to transmit the target data to the server device 50 according to the non-transmission index set by the user by estimating the position value using the external estimation data.

4-6. Other Examples of Transmission Processing

The estimated position value of the data may be used for various purposes. For example, it is conceivable that a receiving side of provided data (hereinafter, also referred to as a “data user”) like an administrator of an external device such as the server device 50 desires to obtain data having high value (position value). On the other hand, it is conceivable that a user on the providing side of data thinks that it is acceptable to transmit data having a low value (position value) but it is not acceptable to give data having a high value (position value) for free. In view of this, an application (service) such as an auction of data according to value (position value) may be provided. In this case, the information processing system 1 may provide a data auction service. For example, the information processing system 1 may present each piece of data together with its position value to data users, receive a bid from each of the data users, and provide the data to the data user who made a highest bid. For example, the information processing system 1 may receive designation of a consideration (minimum successful bid price) of data from the user and provide the data to a data user who bids at a bid price higher than the minimum successful bid price presented by the user. Furthermore, as described above, the suitability of transmitting data may be decided according to the type of task. For example, when the task is a “problem of locating the home” such as home identification, the user's consent according to the position value of the data may be acquired, such as” not giving data of high value as information capable of locating the home”.

5. Effects

As described above, the information processing device (“terminal device 10” in the embodiment, same applies hereafter) according to the embodiment includes the acquisition unit (“acquisition unit 151” in the embodiment, same applies hereafter), the estimation unit (“estimation unit 152” in the embodiment, same applies hereafter), the decision unit (“decision unit 153” in the embodiment, same applies hereafter), and the transmission unit (“transmission unit 154” in the embodiment, same applies hereafter). The acquisition unit acquires a data set in which each data includes information regarding a position. The estimation unit estimates a position value indicating a value related to a position of target data that is data to be a target of value estimation based on evaluation in a predetermined task of data sets including mutually different data. Furthermore, the decision unit decides whether to transmit the target data to the external device based on a non-transmission index that is set based on an instruction of the user. The transmission unit transmits the target data to the external device according to the decision made by the decision unit.

In this manner, the information processing device according to the embodiment estimates the position value of the target data and decides whether to transmit the target data to the external device based on the non-transmission index that is set based on the instruction of the user. Therefore, even in a case where the position value of the target data is high, it is possible to suppress transmission of the target data to the external device. This makes it possible to provide information in a manner desired by the user.

Furthermore, in the information processing device according to the embodiment, the non-transmission index is set based on evaluation in a predetermined task.

In this manner, in the information processing device according to the embodiment, by setting the non-transmission index based on the evaluation for a predetermined task, it is possible to set whether to transmit the target data to the external device according to the task, achieving provision of information in a manner desired by the user.

Furthermore, in the information processing device according to the embodiment, the non-transmission index is set for the position of the target data.

In this manner, in the information processing device according to the embodiment, the non-transmission index is set for the position of the target data, making it possible to suppress transmission of the target data at the position where transmission to the external device is not desired, to the external device. This makes it possible to provide information in a manner desired by the user.

Furthermore, in the information processing device according to the embodiment, the acquisition unit acquires external estimation data used for estimating the position value of the target data from an external device, the estimation unit estimates the position value of the target data using the external estimation data, and the decision unit decides whether to transmit the target data to the external device based on the position value of the target data estimated by the estimation unit and the non-transmission index.

In this manner, the information processing device according to the embodiment estimates the position value of the target data using the external estimation data acquired from the external device, and decides whether to transmit the target data to the external device based on the estimated position value of the target data and the non-transmission index. Therefore, even in a case where it is difficult to decide whether to transmit the target data to the external device only with the information on the side of the information processing device, it is possible to appropriately decide the suitability of transmitting the target data to the external device. This makes it possible to provide information in a manner desired by the user.

Furthermore, in the information processing device according to the embodiment, the estimation unit estimates the position value of the target data based on the acquisition data acquired by the acquisition unit and the external estimation data.

In this manner, the information processing device according to the embodiment estimates the position value of the target data based on the acquisition data different from the target data and based on the external estimation data, making it possible to appropriately estimate the position value of the target data and to provide information in a manner desired by the user.

6. Program

The processing performed by the terminal device 10 described above is implemented by an information processing program according to the present application. For example, the acquisition unit 151 related to the terminal device 10 is actualized by execution of a processing procedure related to the information processing program by the CPU, the MPU, or the like included in the terminal device 10 by the information processing program by using the RAM as a work area. For example, the estimation unit 152 related to the terminal device 10 is actualized by execution of a processing procedure such as the estimation processing related to the information processing program by the CPU, the MPU, or the like included in the terminal device 10 by the information processing program by using the RAM as a work area. Similarly, the other units related to the terminal device 10 are actualized by execution of individual procedures by the information processing program. For example, the information processing program that estimates the position value may be included in a content display application or the like.

Note that the information processing program does not always need to implement all the processing executed by the terminal device 10 according to the present application. For example, the sensor unit 16 detects various types of sensor information in the terminal device 10. At this time, various types of sensor information and the like in the terminal device 10 may be detected by an operating system (OS) installed in the terminal device 10. That is, the information processing program does not have to directly execute the above-described processing executed in the terminal device 10. It is also allowable to receive or detect data acquired by the OS (for example, data acquired using a sensor, a circuit, or the like mounted in the terminal device 10), thereby implementing the processing of the terminal device 10 described above. Furthermore, an information processing program may be included in the OS installed in the terminal device 10.

7. Hardware Configuration

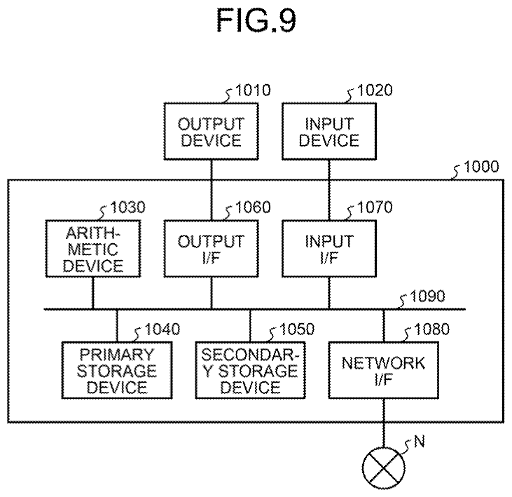

Furthermore, the terminal device 10 according to the above-described embodiment is actualized by a computer 1000 having a configuration as illustrated in FIG. 9, for example. FIG. 9 is a diagram illustrating an example of a hardware configuration. The computer 1000 is connected to an output device 1010 and an input device 1020, and has a form in which an arithmetic device 1030, a primary storage device 1040, a secondary storage device 1050, an output interface (I/F) 1060, an input I/F 1070, and a network I/F 1080 are interconnected by a bus 1090.

The arithmetic device 1030 operates based on a program stored in the primary storage device 1040 or the secondary storage device 1050, a program read from the input device 1020, or the like, and executes various types of processing. The arithmetic device 1030 is actualized by, for example, a central processing unit (CPU), a micro processing unit (MPU), an application specific integrated circuit (ASIC), a field programmable gate array (FPGA), or the like.

The primary storage device 1040 is a memory device such as random access memory (RAM) that temporarily stores data used for various operations performed by the arithmetic device 1030. The secondary storage device 1050 is a storage device that registers data used for various arithmetic operations by the arithmetic device 1030 and various databases, and is actualized by read only memory (ROM), a hard disk drive (HDD), a solid state drive (SSD), flash memory, or the like. The secondary storage device 1050 may be a built-in storage or an external storage. The secondary storage device 1050 may be a removable storage medium such as a USB memory device or a secure digital (SD) memory card. Alternatively, the secondary storage device 1050 may be a cloud storage (online storage), a network attached storage (NAS), a file server, or the like.

The output I/F 1060 is an interface for transmitting information to be output to the output device 1010 that outputs various types of information, such as a display, a projector, and a printer, and is actualized by a connector conforming to a standard such as a universal serial bus (USB), a digital visual interface (DVI), or a high definition multimedia interface (HDMI) (registered trademark), for example. Furthermore, the input I/F 1070 is an interface for receiving information from various input devices 1020 such as a mouse, a keyboard, a keypad, a button, a scanner, and the like, and is actualized by a USB device, for example.

In addition, the output I/F 1060 and the input I/F 1070 may be wirelessly connected to the output device 1010 and the input device 1020, respectively. That is, the output device 1010 and the input device 1020 may be wireless devices.

Furthermore, the output device 1010 and the input device 1020 may be integrated like a touch panel. In this case, the output I/F 1060 and the input I/F 1070 may also be integrated as an input/output I/F.

Note that the input device 1020 may be, for example, a device that reads information from an optical recording medium such as a compact disc (CD), a digital versatile disc (DVD), or a phase change rewritable disk (PD), a magneto-optical recording medium such as a magneto-optical disk (MO), a tape medium, a magnetic recording medium, a semiconductor memory device, or the like.

The network I/F 1080 receives data from another device via the network N and transmits the data to the arithmetic device 1030, and also transmits data generated by the arithmetic device 1030 to another device via the network N.

The arithmetic device 1030 controls the output device 1010 and the input device 1020 via the output I/F 1060 and the input I/F 1070. For example, the arithmetic device 1030 loads a program from the input device 1020 or the secondary storage device 1050 onto the primary storage device 1040, and executes the loaded program.

For example, when the computer 1000 functions as the terminal device 10, the arithmetic device 1030 of the computer 1000 actualizes the function of the control unit 15 by executing a program loaded on the primary storage device 1040. In addition, the arithmetic device 1030 of the computer 1000 may load a program acquired from another device via the network I/F 1080 onto the primary storage device 1040 and execute the loaded program. Furthermore, the arithmetic device 1030 of the computer 1000 may cooperate with another device via the network I/F 1080, and may call a function, data, and the like of the program from another program of the another device to use.

Although some of the embodiments and modifications of the present application have been described in detail with reference to the drawings, these are examples, and therefore the present invention can be implemented in other forms with various modifications and improvements applied based on the knowledge of those skilled in the art, including the embodiments described in the disclosure lines of the invention.

8. Others

Furthermore, among various types of processing described in the above-described embodiments and modifications, all or a part of the processes described as being automatically performed can also be manually performed, or all or a part of the processes described as being manually performed can also be automatically performed using known methods. In addition, the processing procedure, specific names, and information including various types of data and parameters illustrated in the above descriptions and drawings can be arbitrarily altered or modified unless otherwise specified. For example, the various types of information illustrated in individual figures is not limited to the illustrated information.

Furthermore, individual components of each of the illustrated devices are given as a functional concept, and do not necessarily have to be physically configured as illustrated in the figures. That is, the specific form of distribution/integration of each of devices is not limited to the one illustrated in the figure. All or part of the device is functionally or physically distributed/integrated in arbitrary units depending on various loads and usage conditions.

In addition, the above-described embodiments and modifications can be appropriately combined as long as the processes do not contradict each other.

In addition, the above-described terms such as “section, module, unit” can be read as “means” or “circuit”. For example, the acquisition unit can be rephrased as an acquisition means or an acquisition circuit.

According to one aspect of the embodiment, there is an effect that it is possible to provide information in a manner desired by the user.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing device comprising:
an acquisition unit that acquires a data set in which each piece of data constituting the data set includes information regarding a position;
an estimation unit that estimates a position value indicating a value related to a position of target data that is data to be a value estimation target, based on evaluation in a predetermined task of each of the data sets including mutually different data;
a decision unit that decides whether to transmit the target data to an external device based on a non-transmission index that is set based on an instruction of a user; and
a transmission unit that transmits the target data to the external device in accordance with the decision made by the decision unit.

2. The information processing device according to claim 1,
wherein the non-transmission index is set based on the evaluation in the predetermined task.

3. The information processing device according to claim 1,
wherein the non-transmission index is set for the position of the target data.

4. The information processing device according to claim 1,
wherein the acquisition unit acquires external estimation data used for estimating the position value of the target data from an external device,
the estimation unit estimates the position value of the target data using the external estimation data, and
the decision unit decides whether to transmit the target data to the external device based on the position value of the target data estimated by the estimation unit and based on the non-transmission index.

5. The information processing device according to claim 4,
wherein the estimation unit estimates the position value of the target data based on acquisition data acquired by the acquisition unit and based on the external estimation data.

6. An information processing method executed by a computer, the information processing method comprising:
an acquisition step of acquiring a data set in which each piece of data constituting the data set includes information regarding a position;
an estimation step of estimating a position value indicating a value related to a position of target data that is data to be a value estimation target, based on evaluation in a predetermined task of each of the data sets including mutually different data;
a decision step of deciding whether to transmit the target data to an external device based on a non-transmission index that is set based on an instruction of a user; and
a transmission step of transmitting the target data to the external device in accordance with the decision made in the decision step.

7. A non-transitory computer readable storage medium storing an information processing program causing a computer to execute:
an acquisition procedure of acquiring a data set in which each piece of data constituting the data set includes information regarding a position;
an estimation procedure of estimating a position value indicating a value related to a position of target data that is data to be a value estimation target, based on evaluation in a predetermined task of each of the data sets including mutually different data;
a decision procedure of deciding whether to transmit the target data to an external device based on a non-transmission index that is set based on an instruction of a user; and
a transmission procedure of transmitting the target data to the external device in accordance with the decision made in the decision procedure.
